(19) United States
(12) Patent Application Publication
(10) Pub. No.: US 2020/0223004 A1
(43) Pub. Date: Jul. 16, 2020

(54) Soldering Iron Control System

(71) Applicant: Hakko Corporation, Osaka (JP)

(72) Inventors: Toshikazu Mochizuki, Osaka (JP); Hitoshi Takeuchi, Osaka (JP)

(73) Assignee: Hakko Corporation, Osaka (JP)

(21) Appl. No.: 16/738,505

(22) Filed: Jan. 9, 2020

Related U.S. Application Data
(60) Provisional application No. 62/790,623, filed on Jan. 10, 2019.

(51) Int. Cl. B23K 3/03; B23K 3/047

(52) U.S. Cl. CPC B23K 3/033; B23K 3/0478

(57) ABSTRACT

The invention is directed to a control station for a soldering system capable of operating with various types of soldering devices, including various soldering tip configurations, and a program and database of operating parameters that the control station utilizes to identify preferred or optimal power delivery settings for each type of soldering tip size, type of solder and type of work to be soldered so as to have the soldering control station generate and display a suggestion as to the power level settings and requirements for the optimum soldering conditions to users.

### BACKGROUND OF THE INVENTION

Present soldering systems preferably include a control station coupled to a soldering tool with a cable, and multiple types of soldering cartridges that may be inserted into the soldering tool to be powered by the control station. The soldering cartridges may each have a particular tip shape, for example pointed, round, beveled or chiseled, square, rectangular, part conical and iron shapes, and any of these configurations may come in a small, medium or large size and thermal mass. The particular configuration of the tip may require specific powering cycles to maintain the tip temperature in a desired range during the soldering process.

In addition, there are several different types of solder and solder compositions that may be used with the soldering system. The solders may have different melting points, flow characteristics when liquefied, and compositions that may or may not include flux or lead. Accordingly, the type and properties of the solder impact the power delivery requirement of the control station. Finally, the type of work may also impact the power delivery requirement of the control station. For example, single layer as compared to multiple layer printed circuit boards (PCBs) require different power delivery levels. Also, certain types of electronic circuits such as integrated circuit chips and memory chips may only tolerate lower heat settings and thus tip power levels, as compared to other types of circuit elements such as resistors, transistors, capacitors and connection wires. Thus, a number of different factors may need to be considered in determining the optimal tip type and power delivery requirement for particular set of soldering parameters.

I Typically, a user selects the tip type and size, selects the solder and uses his or her experience to select the power level settings of the control station, and then through a trial and error process the user attempts to identify the control settings that provide the best results. t would be beneficial to have a control station that could identify tip characteristics and when instructed as to the type of solder and work parameters or characteristics, provide optimum power settings for the tip and the soldering process.

### SUMMARY OF THE INVENTION

The present invention details a control station that can identify certain tip characteristics, receive instructions as to the type of solder and work parameters or characteristics input by a user via a control panel, and provide optimum power settings for the tip and the soldering process by referencing a database of soldering properties or the control gives a suggestion for better soldering to the user. This improves the reproducibility of soldering.

Alternatively, when the soldering control station is activated and connected to a soldering tool, the user inputs data identifying the soldering tip type, solder and the properties of the work to be soldered and the control station then accesses a database to compare the input information to existing fields within the database to program the control station to provide the proper power delivery to the soldering device matched to the soldering tip, type of solder and work properties. The user can then add the recommended settings into the database for future use/reference. In this manner the user can populate the database with information and properties that are ideal for the user and each soldering task. In either mode of operation, the goal is to have the soldering control station generate and display a suggestion as to the power settings and requirements for the optimum soldering conditions to users.

### BRIEF DESCRIPTION OF THE DRAWINGS

FIG. 1 is a block schematic diagram of a soldering system according to the present invention.

FIG. 1A depicts a variety of soldering tip configurations that may be used with the soldering system of FIG. 1.

FIG. 2 is a simplified schematic of the basic circuitry of the control station of the soldering system of FIG. 1.

FIG. 2A is a box diagram schematic of the circuitry of the control station of the soldering system of FIG. 1

FIG. 3 is a chart of temperature v. time for three different soldering tips.

FIG. 4 is a set of graphs depicting various power supply cycles provided by the control station to a soldering tip.

FIG. 5 is a chart depicting five operating modes for each of three tip sizes.

FIG. 6 is a graph of tip temperature on the Y-axis verses time on the X-axis.

FIG. 7 is another graph of tip temperature on the Y-axis verses time on the X-axis.

FIGS. 8A and 8B are a chart explaining the fields of the database.

FIG. 9 provides various examples of database entries for some specific soldering processes.

FIG. 10 is a representative flow chart of the logic of the program in the control station that accesses and manages the database of soldering properties.

### DETAILED DESCRIPTION OF THE INVENTION

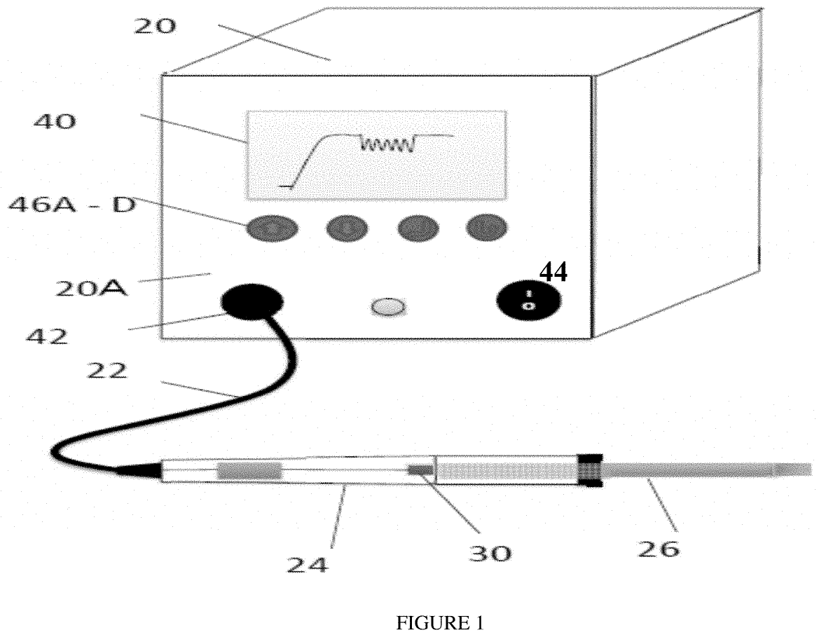

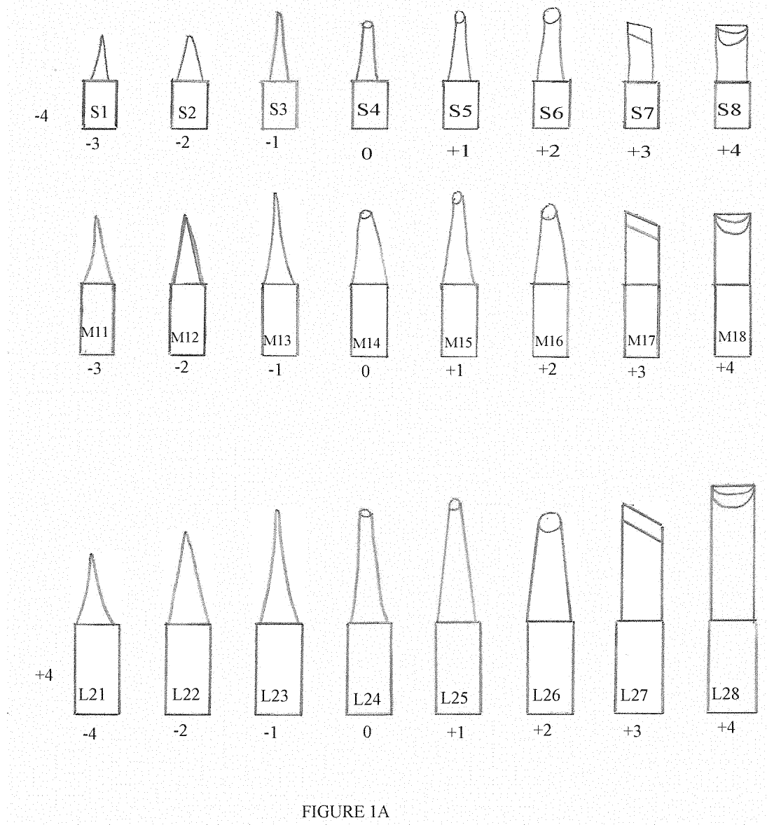

FIG. 1 provides a block and schematic depiction of a solder system of the present invention. The soldering system is configured around a control station 20, which is connected via a cable assembly 22 to a soldering device 24 and cartridge 26. In FIG. 1, the cartridge 26 is depicted as being a soldering cartridge having a beveled tip 28, however it should be appreciated that the cartridge 26 is removable and replaceable with a number of different types of soldering cartridges having other tip sizes and shapes for specific soldering and de-soldering operations including the tips depicted in FIG. 1A. Each type of cartridge comprises an integrated heater, tip temperature sensor, and soldering tip. The control station 20 provides control signals and power to the cartridge 26, which an operator uses to carry out the soldering or de-soldering operations.

The control station 20 has a screen display 40. The control station 20 also includes a socket 42 allowing connection to the cable assembly 22, and a power switch 44 for powering the control station 20 on and off. The control station 20 has a front panel 20A which may include a number of control or data entry components, depicted as buttons 46A, 46B, 46C, and 46D. It may be appreciated that the data entry components may be any number of electrical components including for example toggle switches, knobs, dials, and touch or optical sensors.

FIG. 1 also schematically depicts the soldering device 24 securing the cartridge 26. The cartridge 26 may include a memory element for example a PROM, EPROM or EEPROM. The memory element may be used to store information specific to the type of cartridge that cannot be changed (fixed data) and it may store information that is written to the memory by or via the control station 20 (variable data). The fixed data may include for example a cartridge serial number, tip shape data, and factory set temperature data for each cartridge.

FIG. 1A depicts a variety of tips 28, having various sizes and thermal masses. The tips 28 of the top row depict tips numbered S1-S8 that are all small size tips. The tips 28 of the middle row are medium size tips numbered M11-M18. The tips 28 of the bottom row are large tips numbered L21-L28. The tip numbered M14 in the middle row may be considered in this example as the baseline or no pulse offset size and thermal mass for the soldering system. The tip numbered M11 is smallest tip in the middle row. As compared to the baseline tip numbered M14, the tip numbered M11 has a “−3” pulse offset designation, meaning that the control station will reduce the number of powering pulses by three pulses from the baseline, with all other temperature factors being equal, to power tip numbered M11 to the set point temperature. Tip number M12 has a “−2” designation and tip number M13 has a “−1” designation, because of their respective thermal mass differentials as compared to tip number M14. The control station will reduce the powering pulse by two or one pulses, respectively, for these tip shapes and sizes. Similarly, tips numbered M15, M16, M17 and M18 respectively have a “+1”, “+2”, “+3” and “+4” designation. The control station will utilize those designations to increase the number of pulses to heat those larger thermal mass tip sizes as compared to the baseline tip numbered M14. The smaller tip sizes of the top row all start with a “−4” for the number of pulses, with tip numbered S4 being the baseline of the small tips. Tips numbered S1, S2 and S3 respectively have “−3”, “−2” and “−1” designations as compared to small baseline tip numbered S4. Tip numbers S5, S6, S7 and S8 have a “+1”, “+2”, “+3” and “+4” designation, respectively. As a result, the small tip numbered S8, having the largest thermal mass of the small tips will be powered with the same number of pulses as the tip numbered S14 of the medium tips, effectively because they have the same thermal mass. The large tips of the bottom row all start with a “+4” for the number of pulses, with tip numbered L24 being the baseline for the large tip sizes. Tips numbered L21, L22, L23 have “−3”, “−2” and “−1” designations as compared to large baseline tip numbered L24. Tip numbers L25, L26, L27 and L28 have a “+1”, “+2”, “+3” and “+4” designation, respectively. Accordingly, to heat the largest tip L28 to the same setpoint temperature as the baseline tip numbered L24, the control station will add 8 pulses to the power cycle. While a few different tip shapes and sizes are depicted in FIG. 1A as representative, it is to be understood that every type and size of tip design can be assigned its own subtractive or additive designation so that the control station can make the proper adjustment to the number, and frequency if required, of power pulses.

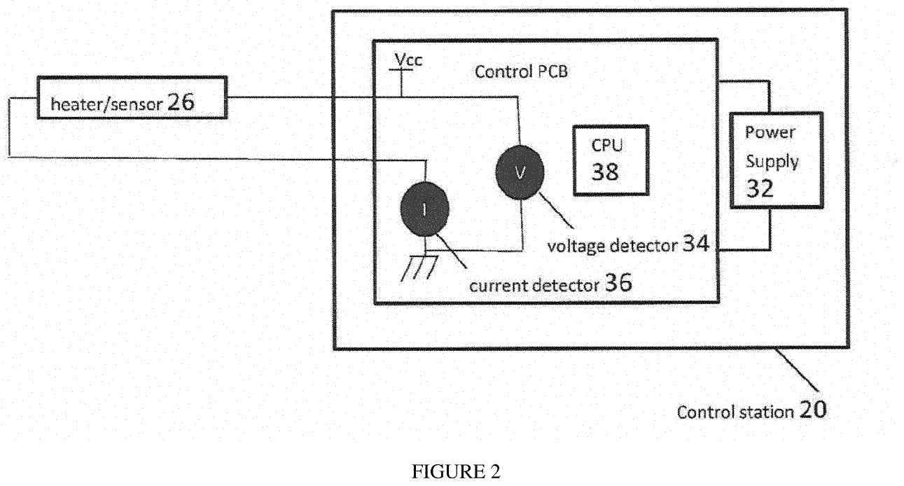

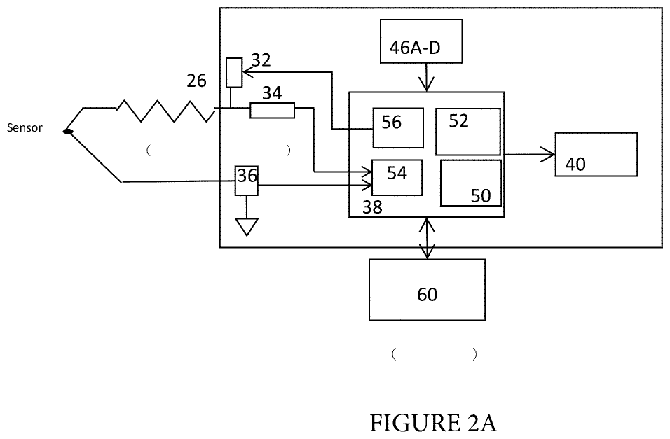

FIG. 2 provides a simplified schematic of the basic circuitry of the control station 20. In this embodiment, the control station 20 includes a power supply 32, voltage detector 34, and a current detector 36, all controlled by a CPU 38 with an associated memory containing a database. FIG. 2A provides a block diagram of the electrical components of the control station 20. As depicted in FIG. 2A, the CPU 38 includes an operation unit processor 50, a memory 52 for storing the database of information on the soldering components and conditions, an input circuit 54 and an output circuit 56. The CPU 38 is connected to and controls the display 40 and it receives input commands from the control or data entry components 46A, 46B, 46C, and 46D (FIG. 1). The CPU 38 is also preferably interactively operable with an external computer or server system 60 having an additional database. The input circuit 54 of the CPU 38 receives current detector data from a current detector 36, as well as sensor and drive voltage data from voltage detector 34. The output circuit 56 of the CPU 38 provides the control instructions to the heater power supply 32. The CPU 38 may also receive information about the cartridge 26 (FIG. 1) from a PROM, EPROM or EEPROM memory element in the cartridge 26 read by the input circuit 54.

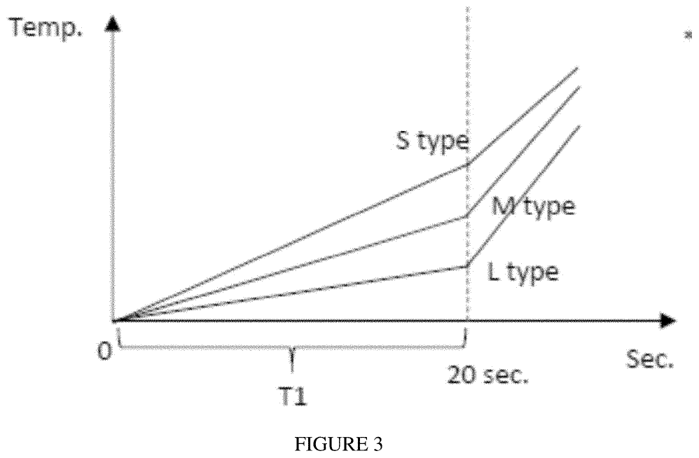

Alternatively, when a new cartridge 26 is connected to the control station 20, the control station 20 may provide test signal to detect the initial temperature of the sensor at the tip of the cartridge, followed by a calibration power cycle and then, after a short delay, a second test signal to detect the calibration temperature of the sensor. Based upon the difference in the two temperatures, the CPU 38 may estimate the cartridge tip thermal capacity and assign an offset designation. FIG. 3 is a chart of temperature v. time for three different baseline tip size examples, small (FIG. 1A tip numbered 4), medium (FIG. 1A tip numbered 14) and large (FIG. 1A tip numbered 24), illustrating how the control station may automatically determine tip properties and identify appropriate power delivery levels. In operation, the control station 20 initially powers the heater of each cartridge 26 with a standardized power cycle, and the control station 20 monitors the temperature rise measured by the tip temperature sensor over a first period, for example twenty seconds. For a small size tip, and thus a smaller thermal mass, the tip temperature rises at a faster rate than the tip temperature of a medium sized tip, which in turn rises faster than the tip temperature of a larger size tip. The chart of FIG. 3 illustrates the tip temperature rise over time for the small (S type), medium (M type) and large (L type) tips. It may be appreciated that each tip size, or each tip having a common thermal mass, may provide a unique temperature rise profile over the first twenty seconds of being powered by the control station 20, allowing the control station 20 to learn which tip size and/or shape is being powered. As also shown in the chart of FIG. 3, once the control station 20 makes the determination of the tip size after the first power up period, the control station 20 may adjust the power delivery for the various sizes so that the medium and large tip sizes receive more power and all three sizes can be brought up to the desired operating temperature, for example 350 degrees centigrade, in approximately the same time interval. In addition, during this tip identity determination, the control station 20 can assign the appropriate subtractive or additive designation as discussed above for FIG. 1A.

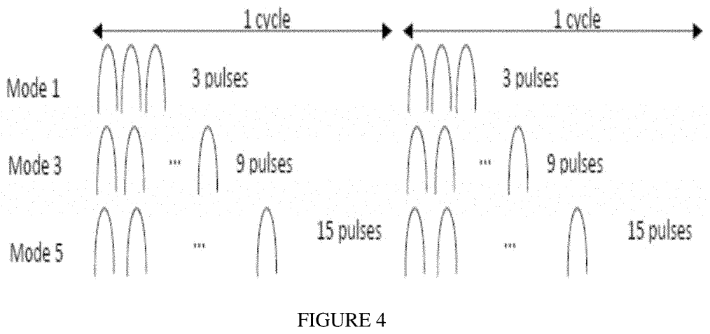

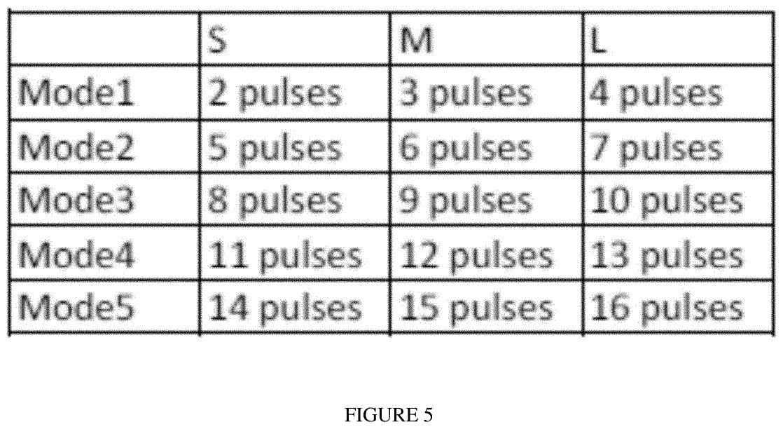

These FIGS. 4 and 5 combined together represent the power modes that the control station 20 may apply to power the various cartridges to obtain or maintain particular operating temperatures. FIG. 4 is a set of exemplary graphs depicting various power supply cycles provided by the control station 20 to a soldering tip. In FIG. 4, there are three different power modes, labeled Mode 1, Mode 3 and Mode 5. Over the course of one cycle, each mode has a specific number of power pulses to energize the heater element of the cartridge. Each cycle defines a particular time interval, for example 0.3 seconds. In Mode 1, there are three pulses per 0.3 second power cycle. In Mode 3, there are nine pulses per 0.3 second power cycle. In Mode 5, there are fifteen pulses per 0.3 second power cycle. Increasing the number of pulses in each power cycle allows the control station to control and/or maintain the temperature of the tip of the cartridge. For example, increasing the number of pulses per power cycle, moving from Mode 1 to Mode 2 or 3, or from Mode 3 to Mode 4 or 5, may be necessary to maintain the set temperature during long or repeated soldering operations to keep the tip temperature as constant as possible. Increasing the number of pulses per power cycle thus maintains the tip temperature when it is being subject to a higher thermal requirement. Additionally, increasing the amplitude of the pulses thereby delivering more power per pulse, or changing the period of the cycle, may be employed to change the tip temperature or adjust the power delivery for varies tip geometries or soldering conditions.

In addition, the graphs of FIG. 4 depicting the pulses per power cycle may be used as a method of establishing baseline temperature set points for various tip geometries and thermal loads. For example, in this operational model, the Mode 1 at the top of FIG. 4 has the control station 20 providing three pulses per cycle in order to power the tip to a low set point temperature, for example 300° C. The Mode 2 in the middle of FIG. 4 has the control station 20 providing nine pulses per cycle in order to power the tip to a baseline set point temperature, for example 350° C. The Mode 5 at the bottom of FIG. 4 has the control station 20 providing fifteen pulses per cycle in order to power the tip to a high set point temperature, for example 380° C. FIG. 4 thus illustrates how the control station may vary the number of pulses per cycle to generate specific temperature profiles for a given tip shape and size.

FIG. 5 is a chart depicting five power supply cycle operating modes for each of three different small (S), medium (M) and large (L) tip sizes. These are provided as examples of the number of power pulses for each mode for each of three exemplary tip sizes and thermal masses.

In one embodiment of the present invention, the modes 1, 2, 3, 4, and 5 may correspond to set point temperatures of 300° C., 325° C., 350° C., 365° C. and 380° C. In the example of FIG. 5, the small tip (S) may be the small tip numbered 1 in FIG. 1A, the medium tip (M) may be the tip numbered 11 in FIG. 1A, and the large tip (L) may be the tip numbered 21 in FIG. 1A. In mode 1, the small tip S can be powered to 300° C. with only two pulses per cycle, 350° C. with eight pulses per cycle and 380° C. with 14 pulses per cycle. By comparison, the medium tip (M) requires three pulses per cycle to reach 300° C., nine pulses per cycle to reach 350° C. and fifteen pulses per cycle to reach 380° C. Because of the relatively larger thermal mass of the large tip (L), it requires four pulses per cycle to reach 300° C., ten pulses per cycle to reach 350° C. and sixteen pulses per cycle to reach 380° C. It may be appreciated, as noted above, that increasing the amplitude of the pulses thereby delivering more power per pulse, or changing the period of the cycle, may be employed to change the tip temperature or adjust the power delivery for varies tip geometries or soldering conditions

In another embodiment of the present invention, which may be depicted in the chart of FIG. 5, the power pulse requirement increases with increasing size, and thermal mass, of the tip to maintain the specific temperature setting. FIG. 5 is provided as an example chart or data set that the control station may reference when the tip temperature drops a set number (X) of degrees X° C. (ex. 5° C.). When the tip temperature drops at other setting levels, (1,2,3° C.), the control station should use other charts or data sets having other power pulse frequencies for each mode for each of the respective tip sizes. Further, the control station may be programmed so that all of the modes are set to the same set point tip temperature, for example 350° C., but the user may select a higher numbered mode to increase the soldering speed because at the higher pulse levels the tip temperature recovers faster during the soldering process. Alternatively, the control station 20 may adjust the mode, pulse numbers or even the cycle frequency based upon tip temperature feedback signals from the tip sensor during the soldering operation.

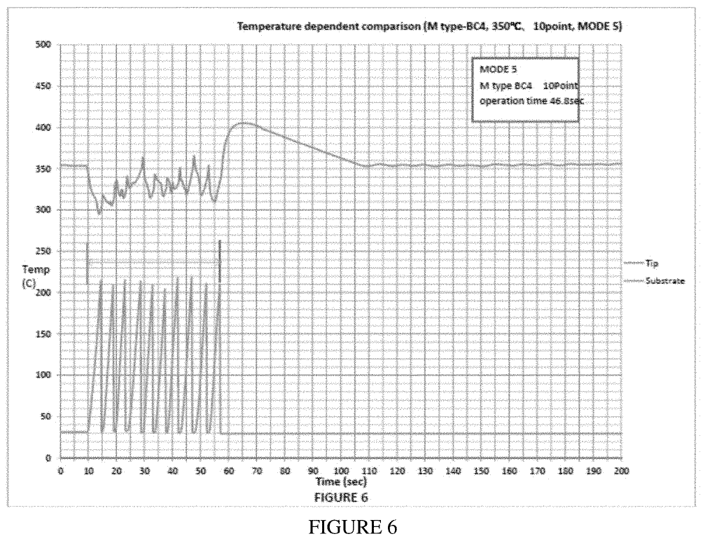

To further illustrate the operation of the power cycle delivery for a specific cartridge and tip geometry, FIG. 6 presents a graph of tip temperature on the Y-axis verses time on the X-axis at power level mode 5. The top line is the tip temperature while the bottom line is the temperature of the substrate or work being soldered. The graph depicts ten soldering events, represented by the ten peaks in the graph of the substrate temperature. The tip temperature as graphed in the top line varies because each time the tip contacts the substrate to perform a soldering operation, and with the associated melting of the solder, heat is transferred from the hotter cartridge tip to the cooler substrate, thereby cooling the tip. The power delivery from the control station to the cartridge may be set in Mode 5 for a large size and thermal mass tip, for example tip numbered 26 in FIG. 1A having a “+6” additive designation, to maintain the tip temperature as close to 350° C. as possible throughout the soldering cycle.

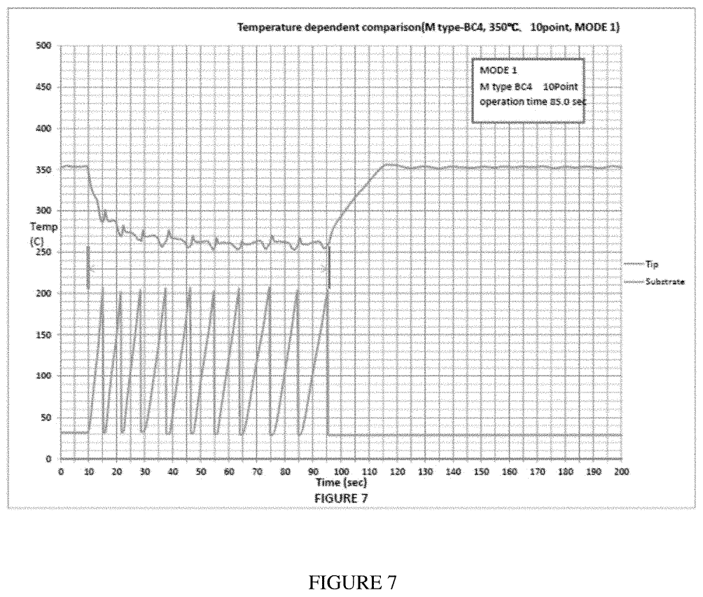

FIG. 7 presents another graph of tip temperature on the Y-axis verses time on the X-axis as in FIG. 6, for a different power level, mode 1. The user of the soldering system can operate the control buttons 46A-46D to set or adjust the power delivery Mode. In addition, once the user determines that the power delivery Mode is appropriate for the specific cartridge and tip configuration and the soldering tasks, the user can store the data for the cartridge tip, solder type, and work properties in the database within the control station 20 for future access and use using the control buttons 46A-46D and adjusting the information depicted on the display 40 to a “record settings” display and entering an “accept recording” option.

It is contemplated that the database within the control station 20 will be programmed with known criteria for various cartridge tips, types of solder and work properties, and that the database will be expandable so that the user may continuously populate the database with additional data and reference points. The following is one example describing how a program has a database that assigns values for each of the criteria and those values are then used to make the temperature/power level adjustments. The control station 20 first determines if there is an identical data information condition stored in the database for a particular “work”, where the work is the item to be soldered, for example a circuit board, and the soldering conditions for that particular circuit board and electrical component to be attached to the circuit board. For example:

Work conditions:
thickness of copper foil on circuit board is 35 μm,
number of layers on circuit board is 2,
land diameter of the contact point on the circuit board is 1.0 mm,
electronic component is 10 g and the component is to be mounted and soldered as a through hole mounting component.

Soldering conditions for the above work and electrical component:
set temperature is 350° C.,
tip shape is 2.4 mm width, medium size flathead screwdriver shape,
pulse number is set to 5 pulses per cycle,
power is 100 J (joules),
time taken for soldering is 10 sec.

The program of the control station will determine or assign a weight or adjustment coefficient for each soldering condition value. For example if the number of layers in the circuit board has the most influence on the amount of heat required for the work conditions, the adjustment coefficient of number of layers (2 in the above criteria) the number of layers adjustment coefficient may be set as “5”. Moreover, if thickness of copper foil has the second most influence, the thickness adjustment coefficient (35 μm in the above criteria) may be set as “4”. The adjustment coefficient of the electronic component may the third most important and thus it may be set as “2” (for 10 g). The control station 20 will sum up the adjustment coefficient factors and determine the appropriate offset from the standardized soldering condition. In this example the total of “11” (5+4+2), may be an adjustment of 2 pulses per cycle and a slightly shorter cycle period. The adjustment coefficients can be set in alternative orders and rated differently for various conditions to provide an offset adjustment to the amount of heat to be delivered per power cycle, as well as the period of each powering cycle. The adjustment coefficient may not be an integer or whole number and it may not necessarily have a straight-line correspondence to the number of added pulses or changing the period of the powering cycle.

Similarly, the soldering conditions may be weighted differently depending on their influence on the amount of heat required to perform the soldering task, for example if a shorter soldering time is required. In addition, the control program may establish as a standard that a summation of the weight factors of “5” may be determinative of a temperature adjustment of a specific amount, such as 10° C., and the number of added pulses per cycle for a 10° C. may be set as 1 added pulse for a weight factor of +5. It may be understood that when the soldering conditions change, the adjustment coefficient factors also change. In the above example, if all other conditions are the same except that the circuit board has only one layer, the number of layers adjustment coefficient may be set as “0”, and the sum of the weight factors would then by “6”. The adjustment coefficients may be set and programmed into the memory of the control station 20, for example the control station 20 may have the set adjustment coefficients programmed as default settings. Alternatively, a user may set or reset the adjustment coefficient factors as the user gains experience with the soldering conditions.

The above example explains how the control station 20 uses known conditions stored in the database to apply to a specific set of work criteria. The control station 20 is also programmed to adapt to new soldering criteria to calculate and display recommended settings for new soldering conditions. When the user initiates a soldering process on a new work and provides an input that the electronic component is 10 g heavier than the electronic component baseline of the database selection, the soldering station may determine that an adjustment coefficient should provide a +20° C. adjustment to make up for the different electronic component 10 g additional weight soldering condition. Thus, for example, the control station 20, or the user, may determine that the 10 g heavier adjustment coefficient of “2” should result in a +20° C. target temperature. However, if the acceptable temperature range for the solder, type of circuit board or electrical component is limited to between −10° C. to +10° C., around the set point temperature of 350° C., then +20° C. is not within the acceptable range and the control station 20 should show recommended condition as coefficient 1=+10° C.

Under a different set of soldering conditions with no limitation on the acceptable temperature range, the control station 20 may determine that the “show set temperature” adjustment recommendation is +40° C. ((+20/weight coefficient 5 ×10° C.=+40° C.) is to be displayed and applied. Similarly, the control station 20 may determine that the “show pulse number” adjustment recommendation, +5 pulses ((+20/weight coefficient 4)×1pulse=+5 pulses) is to be displayed and applied upon acceptance by the user or as the default if the user does not cancel the adjustment. Alternatively, the set temperature adjustment of +40° C. and +4 pulses may be displayed by the control station 20 as the recommended conditions.

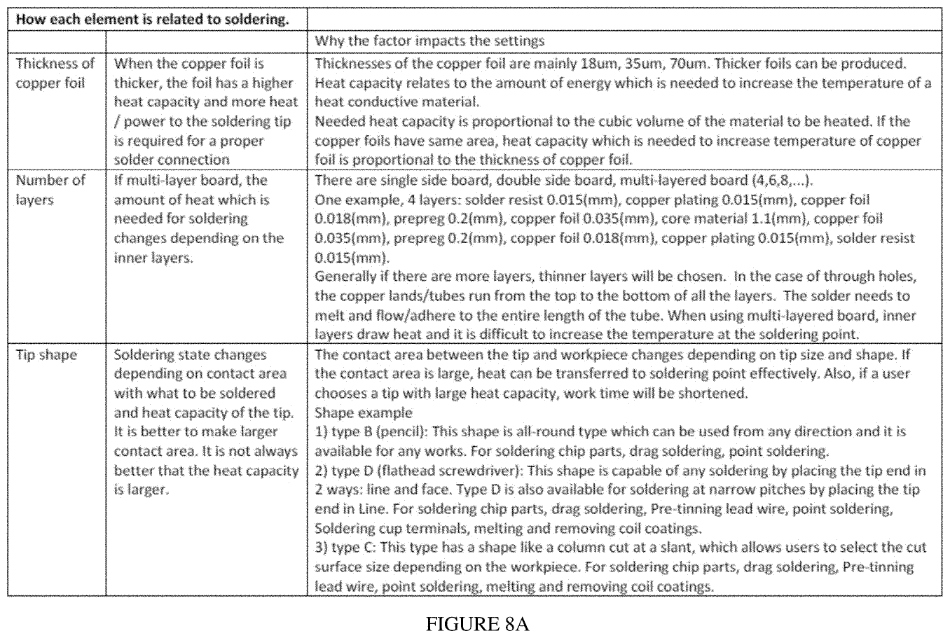

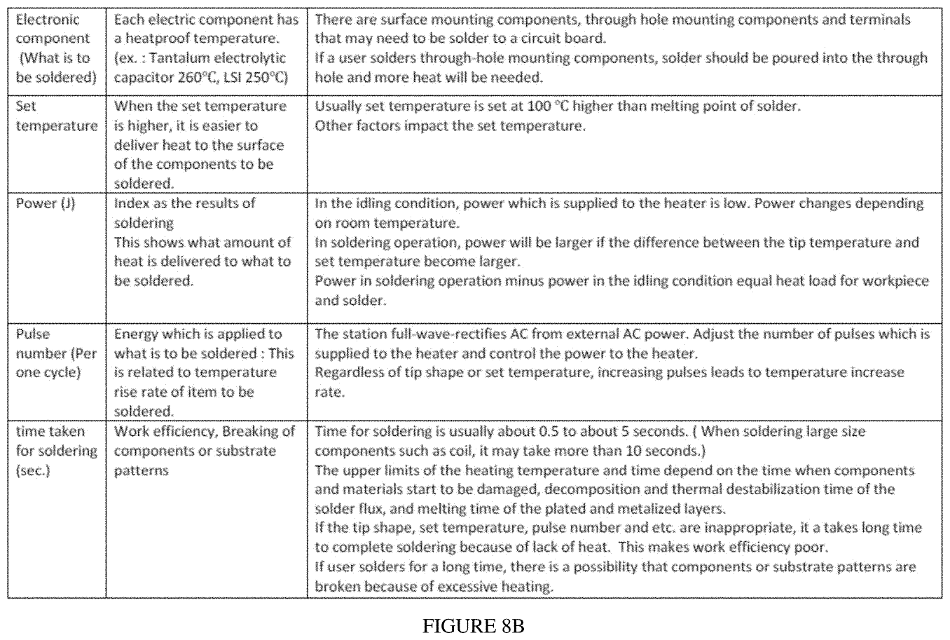

FIGS. 8A and 8B provide a chart explaining the soldering conditions that are preferably included within various fields within the database in the memory of the control station 20, and the relevance of the respective soldering conditions to the soldering activity. Based upon the information provided in FIGS. 8A and 8B, it should be understood that the database may have a number of different values in the field for the thickness of the copper foil of the work, the number of layers of the circuit board, the multiple different tip shapes and sizes, the electronic components to be soldered, the default set temperature for example of the solder, as well as the applied power levels, pulse number per cycle, period of the cycle and the time required for the soldering activity. As indicated in the chart of FIGS. 8A and 8B, the thickness of the copper foil of the circuit board is significant to the soldering process because a thicker foil has a higher heat capacity and therefore more heat needs to be applied by the soldering device, meaning an increased amount of power to the heating element at the soldering tip, for a proper solder connection. There are standard thicknesses for the copper foils of circuit boards, as for example the 18 μm, 35 μm, and 70 μm thickness identified in the FIG. 8A, however other thicknesses may be used in specialty applications. The database may set one of the thicknesses as the baseline, for example 35 μm, and then other thicknesses would require an offset adjustment to the power delivery. The database may need to have a number of different options and offset adjustments to accommodate a wide range of foil thicknesses.

As also reflected in the chart of FIG. 8A, the number of layers in the circuit board is also a soldering condition that impacts the soldering process. For multi-layer circuit boards, the amount of heat that is required changes depending on the configurations of the potential multiple layers. There are single side circuit boards, double sided circuit boards, and multi-layered boards having four, six or eight different circuit layers. As an example of the configuration of a four layer circuit board, the chart of FIG. 8A explains that the thicknesses of the materials within the layers may include a solder resist layer 0.015 mm, copper plating 0.015 mm, copper foil 0.015 mm, prepreg 0.2 mm, copper foil 0.035 mm, core material 1.1 mm, copper foil 0.035 mm, prepreg 0.2 mm, copper foil 0.018 mm, copper plating 0.015 mm, solder resist 0.015 mm. As described, the thicknesses of the copper layers may not even be consistent in the various layers, and in other configurations all of the thicknesses may vary. The circuit board may include through holes having copper lands and/or tubes extending from the top to the bottom of the circuit board. In multi-layer boards, the inner layers of copper draw heat from the copper tubes requiring additional heating of the tip of the soldering device. Accordingly, the database of the memory of the control station 20 may need to have a plurality of fields and different options and offset adjustments to accommodate a wide range of types of circuit boards.

As also reflected in the chart of FIG. 8A, the tip shape and size of the soldering device is also a soldering condition that impacts the soldering process and the control function of the control station 20. The soldering state variables including the contact area and the size and shape of what is to be soldered (or de-soldered). Accordingly, the contact area between the soldering tip, the workpieces and the component to be soldered is a variable in the soldering process requiring the selection of the proper tip size and shape. If the contact area is large, heat transfer to the soldering point is efficient but there is a larger thermal mass to be heated. If the selected soldering tip is large, the time required for a soldering task may be shortened. Accordingly, the database of the memory of the control station 20 may need to have a plurality of fields and different options and offset adjustments to accommodate a wide range of types, sizes and shapes of soldering tips, including those discussed above with respect to FIG. 1A.

As set forth at the top of the chart in FIG. 8B, various electrical components may have specific heat point requirements and limitations. Certain components cannot be overheated in the soldering process or they can be damaged and cause the entire circuit to malfunction. In addition, for circuit boards having multiple layers and through-holes connecting circuits in different layers, the amount of solder required to file the through-holes changes the amount of heat delivered by, and thus power to, the soldering tip. Accordingly, the database of the memory of the control station 20 may need to have a plurality of fields and different options and offset adjustments to accommodate a wide range of soldering components and physical conditions of the circuit board.

As further set forth in the chart of FIG. 8B, the set point temperature for soldering tasks is a variable, as is the power delivery requirement of the cartridge and tip, the number of pulses per cycle and the cycle period, and the time allotted for repetitive soldering tasks are additional factors that the database of the memory of the control station 20 may need to accommodate in a plurality of fields and respective offset adjustments.

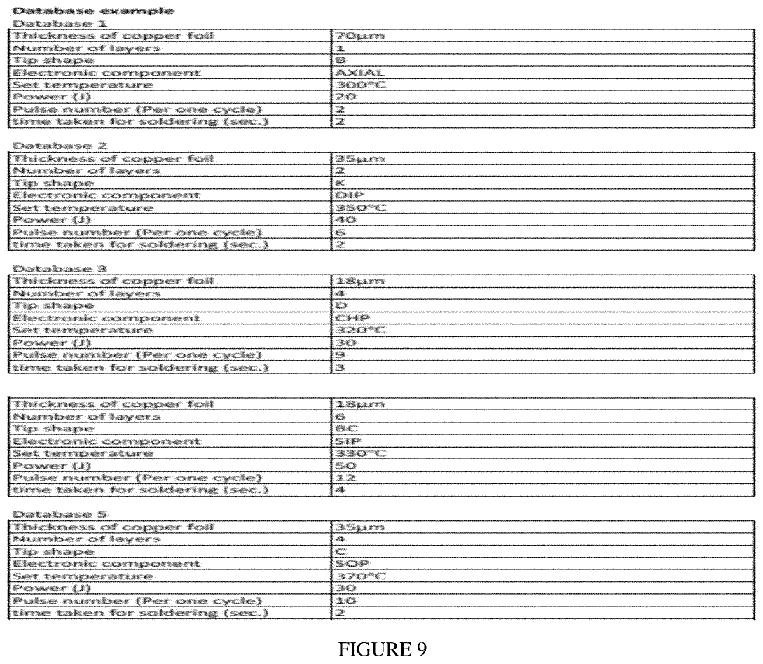

FIG. 9 provides various examples of initial baseline database entries for some specific soldering processes that may be programmed into the database of the control station 20. These baseline database entries can then be used by the control station 20 to make determinations of offset adjustments that may need to be applied for soldering conditions that deviate from the baseline database entries. For example, once the control station identifies the particular tip being used, as discussed above or based upon an input from the user, and the user selects a target temperature and inputs the other soldering conditions, the control station 20 determines the closest baseline database entry from examples 1-5 of FIG. 9, then applies the offset adjustments based upon the deviations as between the baseline database entry and the input for the particular soldering task. As the control station 20 is used on a greater variety of soldering projects, the control station 20 can add additional desirable baseline database entries to populate the database and allow the experience and continued use to refine the control station preset programming.

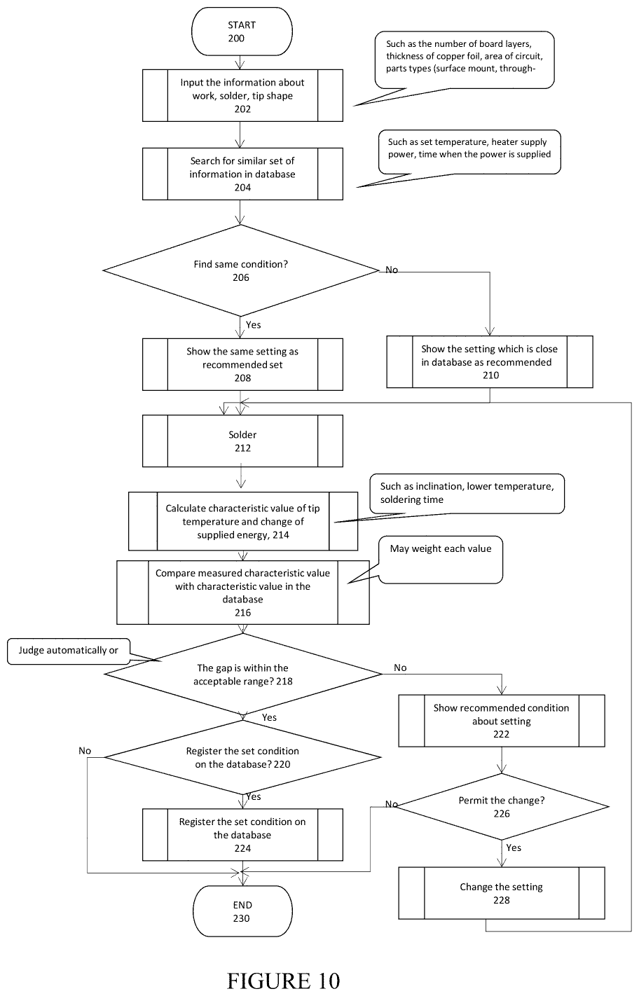

FIG. 10 is a representative flow chart of the logic of the program in the control station 20 that accesses and manages the database of soldering properties. The program is initiated at the start box 200, where the program places the control station 20 in an operational mode allowing data entry by a user. The program then proceeds to an input information box 202 where the program causes the display screen 40 of the control station 20 to prompt a user to enter data about the type of work to be soldered, the solder properties and the cartridge tip shape. After receiving the data input by the user, the program advances to search box 204, where the program searches the database for an identical or most similar set of data information for the work to be soldered, the solder properties and the cartridge tip shape, to identify the preferred power setting for the cartridge.

Upon querying the database, the program advances to decision step 206, where the program determines if the identical set of data information is in the database. If the determination is yes, the program advances to display step 208 where the program causes the display 40 of the control station 20 to display the recommended setting for the power level to properly power the cartridge for the particular set of soldering properties, and sets the power level at that setting. If at decision step 206 the identical set of data information is not found in the database, the program advances to a recommend settings step 210, where the program identifies and causes the display 40 of the control station 20 to display a proposed recommended setting for the power level to properly power the cartridge for the particular set of soldering properties, and sets the power level at that setting.

After either of steps 208 and 210, the program advances to a soldering step 212, where the program prepares to monitor the soldering operations performed by the user, and the power requirements of the cartridge and tip during the soldering process. The program then advances to step 214, where the program receives tip temperature data from the temperature sensor of the cartridge 26, and calculates the characteristics values of the tip temperature changes and changes in the required power supply to the cartridge 26 by the control station 20. The calculations may include identifying any inclination of the tip temperature over time measurement, lower tip temperatures outside of a set range for the set point tip temperature, and the soldering time for each soldering task.

The program then advances the comparison step 216 where the program compares the measured characteristic values with the characteristic values sored in the database associated with the particular power level setting recommended in steps 208 or 210. In this comparison, the program may assign a weighting factor to one or more of the soldering task properties, for example the tip temperature setting and solder time may be weighted more heavily than the type of solder or the thickness of the foil.

Following the comparison step, the program advances to a determination step 218, where the program determines whether the differences or gaps between the measured values and the database set point values is within an acceptable range. Alternatively, the program may automatically make the determination on a continuing basis and cause the control station to adjust the power delivery to minimize the differences or gaps. If the determination step 218 the program determines that the differences or gaps between the measured values and the database set point values are within an acceptable range, the program advances to register prompt step 220 where the program causes the display 40 of the control station 20 to display a prompt to the user to register the set of conditions in the database. However, if at the determination step 218 the program determines that the differences or gaps between the measured values and the database set point values are not within an acceptable range, the program advances to display recommendation step 222, where the program causes the display 40 of the control station 20 to display a recommendation to change the condition settings for the particular set of soldering properties entered by the user at step 202.

If at register prompt step 220 the determination is made to register the power settings for the set of soldering properties entered at step 202 in the database, then the program advances to the register step 224 where the program causes the data associated with the soldering properties, power levels and measured characteristics to be registered in the database. After step 224, or when at prompt step 220 the determination is to not register the settings, the program advances to the end step 230.

As reflected in the flow chart of FIG. 10, after display recommendation step 222, the program advances to change decision step 226, where the program causes the display 40 of the control station 20 to display a prompt to the user to allow the recommended changes to be made to the setting conditions determined at step 222. If the user declines to allow the recommendations to be entered, then the program advances to the end step 230. However, if at step 226 the user authorizes the changes, then the program advances to step 228 where the changes to the power delivery settings associated with the particular set of soldering conditions are entered into the database, the control station power level settings are reset, and the program returns to the beginning of the soldering step 212.

The control station 20 may alternatively execute a decision tree at step 222 of FIG. 10 in order to provide a recommended temperature “T” to the user, with an associated power pulse adjustment and time cycle. For example, a decision tree may arrange the work conditions in a hierarchy to guide a user through the process, or if the parameters are all entered and known, the control program can process the decision tree. One example of a decision tree would have the following rankings and hierarchy, and resulting recommendation display:

The foregoing description of the control program logic is intended to be exemplary, and other steps or modifications may be made to account for variations in soldering processes and components. The control program described above allows the control station to prompt the user to add new data points and soldering property characteristic fields to the database, so that as the database in the control station 20 is populated with more entries the determination at decision step 206 will more frequently be yes. The invention contemplates that the control station 20 will be initially programmed with a populated database of known soldering properties and associated power levels. In addition, the invention contemplates that the control stations may be adapted and configured either through cable connectors or wireless connectivity to communicate with other control stations in the same facility, or with a host machine such as a personal computer or tablet, whereby the control station may transfer data field information to the host machine, and the host machine may assimilate data field information from a number of control stations and repopulate the database in the control stations with additional data fields. In this manner, the database of each control station can be expanded so that settings and recommendations for complicated soldering processes can be shared between control stations.

Further, the system and program allow the user to monitor and adjust the soldering conditions by interacting with the control station 20 and the control program. For example, if the user determines that at the present setting the soldering time is too long, the user can identify that issue to the control program to get a new power level mode recommendation, or the user may change the power mode and attempt the soldering process to determine if the time is correct. To make the changes, the user may change the set temperature, the tip shape or the work properties. Preferably, the control program will then provide recommendations on the power mode or the set temperature. Once the user determines that the soldering process is acceptable, the user can then instruct the program to add the revised settings and soldering conditions data into the database, step 226 of the control program.

The invention has been described in detail above in connection with the figures, however it should be understood that the system may include other components and enable other functions. Those skilled in the art will appreciate that the foregoing disclosure is meant to be exemplary and specification and the figures are provided to explain the present invention, without intending to limit the potential modes of carrying out the present invention. The scope of the invention is defined only by the appended claims and equivalents thereto.

1) A soldering system comprising: a control station programmed to accept soldering condition information input from soldering components or input by a user, and a control program to access a database of stored soldering condition parameters to identify and recommend a power level for a soldering tip coupled to the control station of the soldering system.

2) The soldering system of claim 1, wherein said control station further comprises: a central processing unit having an operating circuit, memory, output circuit and input circuit, the central processing unit programmed to accept soldering condition information input from soldering components or input by a user.

3) The soldering system of claim 2, wherein said soldering condition information includes one or more of: tip shape, number of layers of the work, thickness of copper foil of the work, area of land pattern of the work, and type of electronic component.

4) The soldering system of claim 2, wherein said central processing unit further comprises a control program to access said database of stored soldering condition parameters in said memory of said central processing unit to identify a stored set of soldering condition information parameters most similar to the soldering condition information input from said soldering components or input by a user and said control program executing a decision program to display a recommended power level for a soldering tip coupled to said control station of the soldering system.

5) The soldering system of claim 3, wherein said soldering condition information concerning tip shape includes weight adjustment factors associated with each of a number of different tip shapes and tip sizes stored in said database.

6) The soldering system of claim 3, wherein said soldering condition information concerning number of layers of the work includes adjustment coefficient factors associated with each of a number of different types of circuit boards stored in said database.

7) The soldering system of claim 3, wherein said soldering condition information concerning thickness of copper foil of the work, area of land pattern of the work, and type of electronic component includes adjustment coefficient factors associated with each of a number of different thickness of copper foil of the work, area of land pattern of the work, and type of electronic component stored in said database.

8) The soldering system of claim 1, wherein said recommended power level is displayed on said control station and automatically set as the power level for said soldering tip.

9) A soldering system comprising:
a control station including a central processing unit having an operating circuit, memory, output circuit and input circuit, the central processing unit programmed to accept soldering condition information input from soldering components or input by a user, the soldering condition information including: tip shape, number of layers of the work, thickness of copper foil of the work, area of land pattern of the work, and type of electronic component;
said central processing unit further including a control program to access a database of stored soldering condition parameters to identify a stored set of soldering condition information parameters most similar to the soldering condition information input from said soldering components or input by a user and said control program executing a decision program to display a recommended power level for a soldering tip coupled to said control station of the soldering system.

10) A method of controlling soldering, comprising the steps of:
inputting soldering condition information to a control station;
accessing stored soldering condition information in a memory to provide a suggested soldering condition for said input information.

11) The method of claim 10, wherein soldering condition information input from soldering components or input by a user includes at least one of: tip shape, number of layers of the work, thickness of copper foil of the work, area of land pattern of the work, and type of electronic component.

12) The method of claim 10, wherein the stored soldering condition information includes at least one of: setting temperature, power (J), pulse number per one cycle or time taken for soldering.

13) The method of claim 10, further including the steps:
comparing soldering condition information input by user and soldering condition information stored in a memory;
finding soldering condition information being most similar to input information; and
displaying identical or most similar set of data information as the recommended setting.

14) The method of claim 10, further including the steps:
comparing temperature, power and time measured during soldering and soldering condition information stored in a memory; and
displaying the difference between said measured temperature, power and time and the temperature, power and time data stored in said memory.

15) The method of claim 10, further including the step:
assigning a weighting factor to one or more of the soldering task properties.

16) The method of claim 10, further including the step:
setting at least one set of data as fixed data in said memory database.

17) The method of claim 10, further including the step:
displaying on said control station and automatically setting as the power level for said soldering tip said recommended power level for the soldering condition.
